(19) United States
(12) Patent Application Publication
(10) Pub. No.: US 2008/0076360 A1
(43) Pub. Date: Mar. 27, 2008

(54) Apparatus for combining two radios on a single antenna

(75) Inventor: Michael Thomas Curtin, Melbourne, FL (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Northrop Grumman Corporation, Los Angeles, CA (US)

(21) Appl. No.: 11/525,417

(22) Filed: Sep. 22, 2006

(51) Int. Cl. H04B 1/44; H04B 1/04; H04B 7/08

(52) U.S. Cl. 455/78; 455/132; 455/103

(57) ABSTRACT

An apparatus comprises first and second radios, an antenna, a four-port combiner connected between each of the first and second radios and the antenna, a complex vector modulator for producing a correction signal in response to a sample signal and an error signal, a first switch for routing the sample signal to the complex vector modulator and for routing the correction signal to one of the first and second radios, and a second switch for routing the error signal to the complex vector modulator.

### FIELD OF THE INVENTION

This invention relates to radio systems, and more particularly, to such systems in which multiple radios are connected to a common antenna.

### BACKGROUND OF THE INVENTION

In communications systems that include multiple transceivers, it is desirable to reduce interference resulting from signals produced by the collocated transceivers.

In a typical interference canceling system that might be used when two radios are located in near proximity and with limited radio frequency (RF) isolation, each radio operates independently as either a receiver or transmitter without dependency on the operating mode of the other radio. The system should be designed such that operation of one radio does not affect operation of the other.

When two radios with limited RF isolation are operated such that one radio is transmitting and the other is receiving, an interference canceling system may be employed to cancel the transmitter's RF signal at the receiver. A sample of the transmitted signal can be routed to an interference canceller via a transfer switch. Then the interference canceller adjusts the amplitude and phase of the sample signal to produce a correction signal. The correction signal is routed to the receiver via the transfer switch. A downstream error signal is extracted and fed back to the interference canceller and used to control the correction signal. The interference canceller adjusts the correction signal to minimize the error signal by causing the correction signal to sum destructively with the portion of the transmitted signal that is received via the receiver system antenna.

To reduce the size of a multiple transceiver system, it is desirable to connect the transceivers to a common antenna. Thus there is a need for an interference cancellation device in a multiple transceiver system that uses a common antenna.

### SUMMARY OF THE INVENTION

The invention provides an apparatus comprising first and second radios, an antenna, a four-port combiner connected between each of the first and second radios and the antenna, a complex vector modulator for producing a correction signal in response to a sample signal and an error signal, a first switch for routing the sample signal to the complex vector modulator and for routing the correction signal to one of the first and second radios, and a second switch for routing the error signal to the complex vector modulator.

In another aspect, the invention provides an apparatus comprising first and second radios, an antenna, a four-port combiner connected between each of the first and second radios and the antenna, wherein the four-port combiner produces a sample signal, a complex vector modulator for producing a correction signal in response to the sample signal and an error signal, a first switch for routing the correction signal to one of the first and second radios, and a second switch for routing the error signal to the complex vector modulator.

In yet another aspect, the invention provides an apparatus comprising first and second radios, an antenna, a four-port combiner connected between each of the first and second radios and the antenna, wherein the four-port combiner produces a sample signal, a complex vector modulator for producing a correction signal in response to the sample signal and an error signal, a circulator for routing the correction signal to the four-port combiner, and a switch for routing the error signal to the complex vector modulator.

### BRIEF DESCRIPTION OF THE DRAWINGS

FIG. 1 is a schematic diagram of a typical interference canceling system.

FIG. 2 is a schematic diagram of an interference canceling system constructed in accordance with one embodiment of the invention.

FIG. 3 is a schematic diagram of an interference canceling system constructed in accordance with another embodiment of the invention.

FIG. 4 is a schematic diagram of an interference canceling system constructed in accordance with yet another embodiment of the invention.

### DETAILED DESCRIPTION OF THE INVENTION

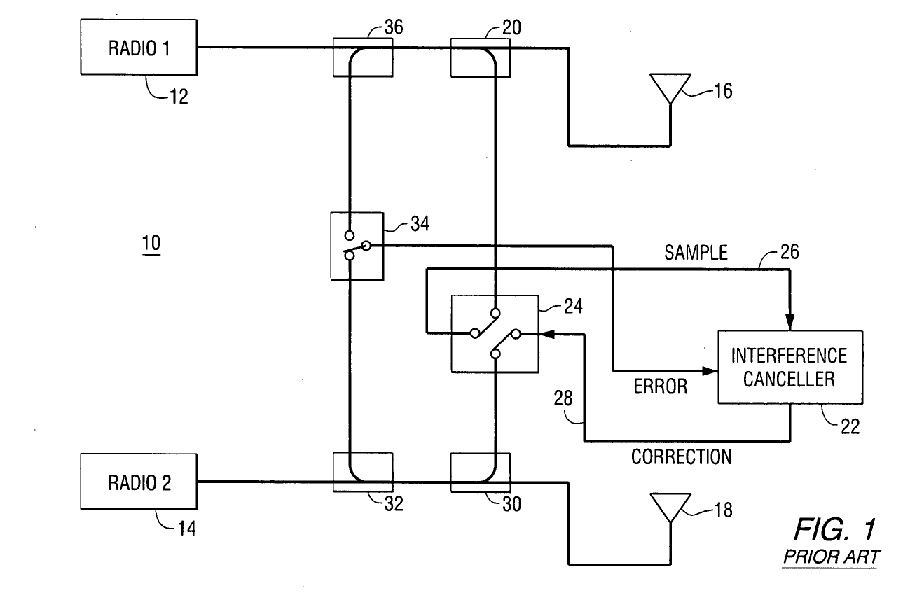

FIG. 1 is a schematic diagram of a typical interference canceling system 10 that might be used when two radios are located in near proximity and with limited radio frequency (RF) isolation. The system includes a first radio 12 and a second radio 14. The first radio is connected to a first antenna 16 and the second radio is connected to a second antenna 18. Each radio operates independently as either a receiver or a transmitter without dependency on the operating mode of the other radio.

In FIG. 1, when radio 12 is transmitting and radio 14 is receiving, a directional coupler 20 provides a sample of the transmitted RF signal to the interference canceller 22 via a transfer switch 24. The directional coupler 20 is limited in coupling value to keep the through line loss to an acceptable value; for example, a 10 dB coupler will have approximately 1 dB through line loss. The interference canceller adjusts the amplitude and phase of the sample signal on line 26 to produce a correction signal on line 28. The correction signal is routed to the receiver system via the transfer switch and a directional coupler 30. A downstream error signal is extracted by directional coupler 32 and fed back to the interference canceller through single pole double throw (SPDT) switch 34 to be used to control the correction signal. The closed-loop interference canceller adjusts the correction signal to minimize the error signal by causing the correction signal to sum destructively with the portion of the transmitted signal that is received via the receiver system antenna 18. When radio 12 is receiving and radio 14 is transmitting, the positions of the SPDT switch and the transfer switch are changed, and directional coupler 36 extracts the error signal that is fed to the interference canceller.

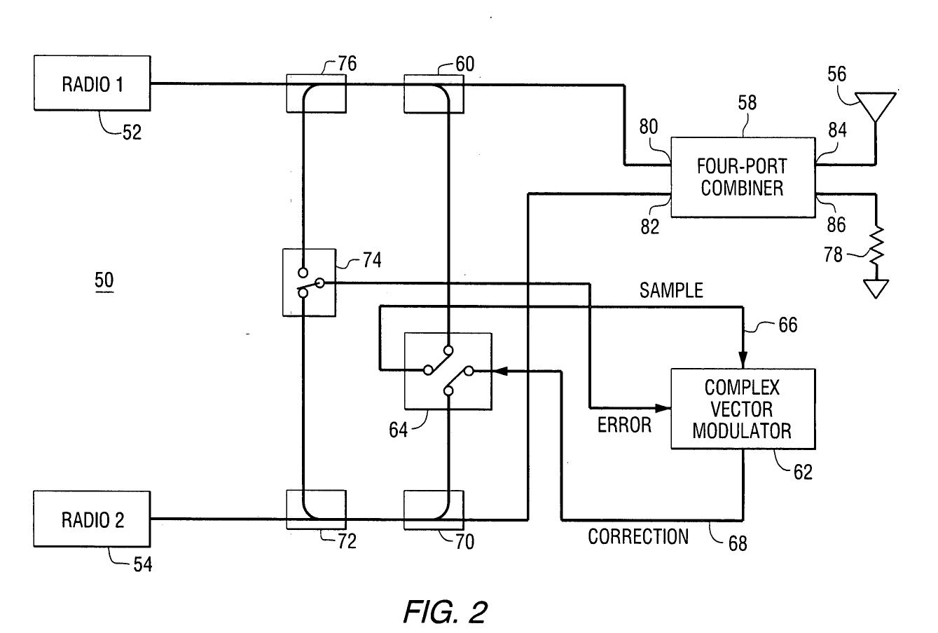

FIG. 2 is a schematic diagram of an interference canceling system 50 constructed in accordance with one embodiment of the invention. FIG. 2 shows a system in which the two radios 52, 54 are coupled to a common antenna 56 through a four-port combiner 58. The four-port combiner can be implemented using a hybrid coupler.

When radio 52 is transmitting and radio 54 is receiving, a directional coupler 60 provides a sample of the transmitted RF signal to a complex vector modulator 62 via a transfer switch 64. The directional coupler 60 is limited in coupling value to keep the through line loss to an acceptable value; for example, a 10 dB coupler will have approximately 1 dB through line loss. The complex vector modulator adjusts the amplitude and phase of the sample signal on line 66 to produce a correction signal on line 68. The correction signal is routed to the receiver system via the transfer switch and a directional coupler 70. A downstream error signal is extracted by directional coupler 72 and fed back to the complex vector modulator through single pole double throw (SPDT) switch 74 to be used to control the correction signal.

The closed-loop complex vector modulator adjusts the correction signal to minimize the error signal by causing the correction signal to sum destructively with the portion of the transmitted signal that is received via the antenna 56. The complex vector modulator can be an application-specific integrated circuit complex vector modulator. After decomposing the error signal into complex in-phase and quadrature-phase (I&Q) error components, these components can be used by a closed-loop control system to adjust the amplitudes of the I&Q components of the sample signal to create a correction signal that can minimize the error signal.

When radio 52 is receiving and radio 54 is transmitting, the positions of the SPDT switch and the transfer switch are changed, and directional coupler 76 extracts the error signal that is fed to the complex vector modulator. Most radios include a push-to-talk (PTT) or ready-to-send (RTS) input signal that causes the radio to go into a transmit mode. These signals could be used to control the positions of the SPDT switch and the transfer switch. If this signal is not available in a particular system, then detection of transmitted power (involving additional equipment) can provide this same information.

Generally the system is not limited to two radios. But some system-level advantages disappear with greater numbers. For example, if there are three radios (two transmit, one receive) in some combiner arrangements, a single error signal has the potential to have samples of two transmitters on the same port. To use interference cancellation, the two transmitting signals would have to be separated and applied to an interference canceller independently of each.

The four-port combiner is a four-port device that includes ports 80, 82, 84 and 86. The termination (shown as resistor 78) on port 86 of the four-port combiner absorbs half of the power of each of the transmitted signals. Various types of hybrid couplers can be used as the four-port combiner, such as 0°, 90° or 180° couplers. Other system factors may drive the choice.

The coupler can be a commercially available device. Port names vary by manufacturer. Furthermore, the port names also vary by the type of coupler (0° vs. 90° vs. 180°). However, there are generally two classes of terminals. Terminals 80 and 82 can be generically designated as inputs, and terminals 84 and 86 can be designated as outputs. However, one skilled in the art will know that four-port devices are symmetrical. Therefore, outputs can be inputs, and inputs can be outputs.

The interference canceling system of the invention is used to minimize the error signal by causing the correction signal to sum destructively with the portion of the transmitted signal that is received via the receiver system antenna. In the configuration of FIG. 2, the interfering signal comes from the fact that the antenna reflects a portion of the transmitted signal.

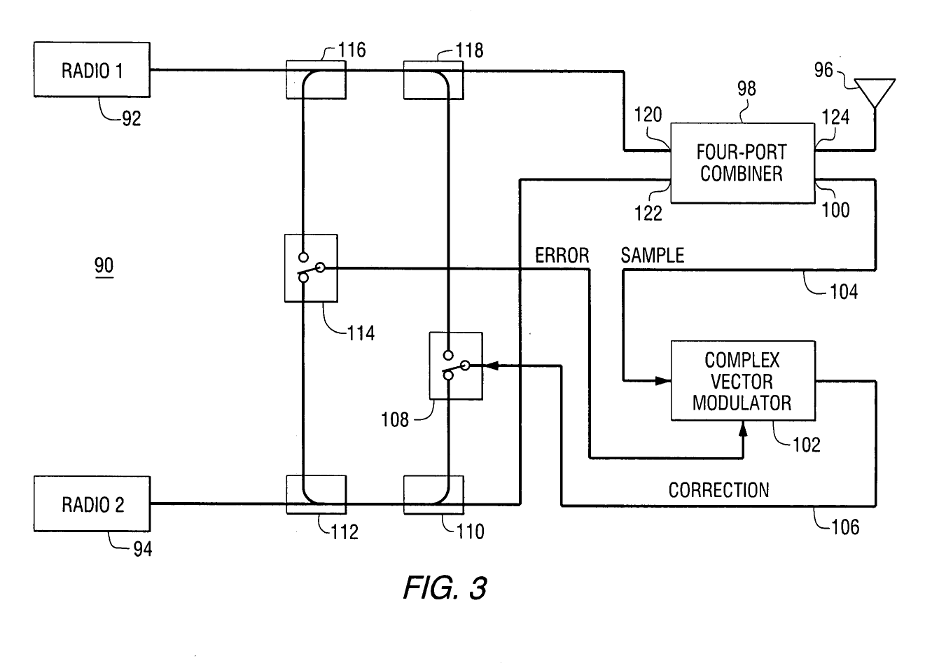

FIG. 3 is a schematic diagram of an interference canceling system 90 constructed in accordance with another embodiment of the invention. FIG. 3 shows an improvement to the system in FIG. 2. In the system of FIG. 3 two radios, 92 and 94, are coupled to a common antenna 96 through a four-port combiner 98. When radio 92 is transmitting and radio 94 is receiving, a sample of the transmitted RF is extracted at a port or terminal 100 of the four-port combiner and fed to the complex vector modulator 102 on line 104. The complex vector modulator adjusts the amplitude and phase of the sample signal on line 104 to produce a correction signal on line 106. The correction signal is routed to the receiver system, via an SPDT switch 108, and a directional coupler 110. A downstream error signal is extracted by directional coupler 112 and fed back to the complex vector modulator through single pole double throw (SPDT) switch 114 to be used to control the correction signal. The closed-loop complex vector modulator adjusts the correction signal to minimize the error signal by causing the correction signal to sum destructively with the portion of the transmitted signal that is reflected at the antenna 96. When radio 92 is receiving and radio 94 is transmitting, the positions of the SPDT switches are changed, the directional coupler 116 extracts the error signal that is fed to the complex vector modulator, and the directional coupler 118 is used to feed the correction signal to the radio 92.

The four-port combiner is a four-port device that includes ports 120, 122, 124 and 100. In the configuration of FIG. 3, the sample signal is taken from port 100 of the four-port combiner. This allows the transmit sample to be approximately equal to the transmitted signal at the antenna, which is far better than that available using the directional coupler. In any system in which two radios are combined on a single antenna, it is inescapable that only half of the transmitted power arrives at the antenna and the other half is generally dissipated in a termination port of the coupler as shown in FIG. 2. Additionally the system of FIG. 3 is somewhat reduced in complexity by swapping the transfer switch for a second SPDT switch.

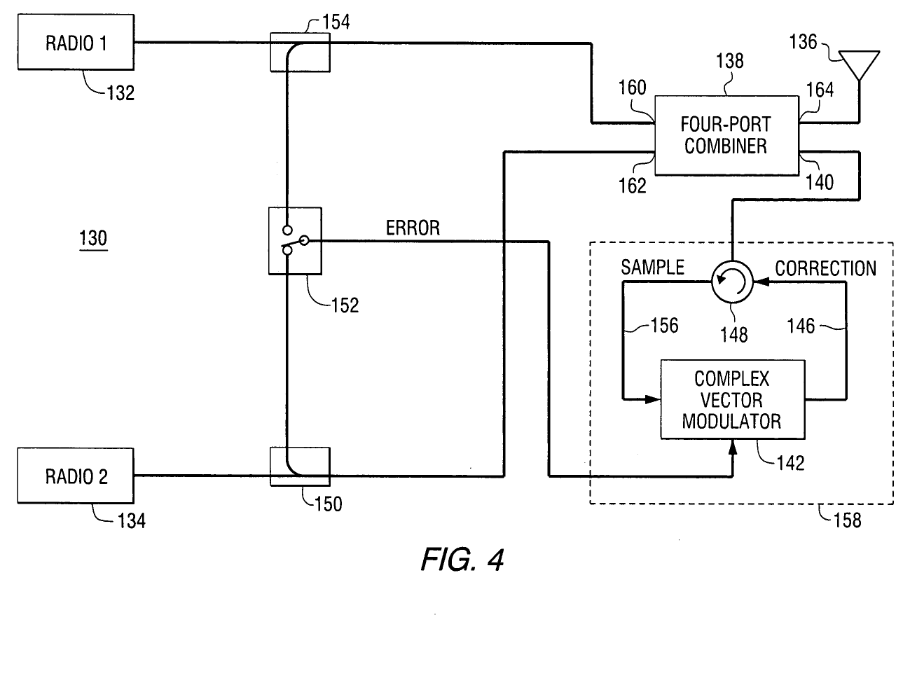

FIG. 4 is a schematic diagram of an interference canceling system 130 constructed in accordance with another embodiment of the invention. FIG. 4 shows a further improvement to the system in FIG. 3. FIG. 4 shows a system in which the two radios 132, 134 are coupled to a common antenna 136 through a four-port combiner 138. When radio 132 is transmitting and radio 134 is receiving, a sample of the transmitted RF is extracted at the fourth terminal 140 of the four-port combiner and fed to the complex vector modulator 142 on line 144 (through circulator 148). The complex vector modulator adjusts the amplitude and phase of the sample signal on line 156 to produce a correction signal on line 146. The correction signal is fed back to the four-port combiner via a circulator 148. A downstream error signal is extracted by directional coupler 150 and fed back to the complex vector modulator through single pole double throw (SPDT) switch 152 to be used to control the correction signal. The closed-loop complex vector modulator adjusts the correction signal to minimize the error signal by causing the correction signal to sum destructively with the portion of the transmitted signal that is reflected at the antenna 136. When radio 132 is receiving and radio 134 is transmitting, the position of the SPDT switch is changed, and the directional coupler 154 extracts the error signal that is fed to the complex vector modulator. The circulator directs the sample signal from line 144 to line 156 and directs the correction signal from line 146 to line 144.

The four-port combiner is a four-port device that includes ports 160, 162, 164 and 140. In the configuration of FIG. 3, the sample signal is taken from port 100 of the four-port combiner. In FIG. 4, a circulator is used to feed the correction signal back into the four-port combiner. The complexity of the system is further reduced by eliminating two directional couplers (and the attendant through line loss) and one RF switch, but adding only the circulator. FIG. 4 additionally exploits the reciprocal nature of the four-port coupler to use it as a means of injecting the correction signal, further eliminating two directional couplers.

In addition to the reduced number of components, the systems in FIGS. 3 and 4 utilize RF power that is generally thrown away as heat for the benefit of having more sample power to use for signal cancellation and, as in FIG. 4, eliminating the sample couplers.

The objects in the dashed box 158 in FIG. 4 create a useful device in the form of an active RF termination. Using an error/control signal developed externally, the active RF termination is able to produce a load with a reflection coefficient at any phase. This active RF termination can be used, as in this case, to minimize a reflected signal or to cause the reflected signal to have specific amplitude and phase characteristics.

While the invention has been described in terms of several embodiments, it will be apparent to those skilled in the art that various changes can be made to the described embodiments without departing from the scope of the invention as set forth in the following claims.

What is claimed is:

1. An apparatus comprising:
first and second radios;
an antenna;
a four-port combiner connected between each of the first and second radios and the antenna;
a complex vector modulator for producing a correction signal in response to a sample signal and an error signal;
a first switch for routing the sample signal to the complex vector modulator, and for routing the correction signal to one of the first and second radios; and
a second switch for routing the error signal to the complex vector modulator.

2. The apparatus of claim 1, further comprising:
a first directional coupler for extracting the sample signal and for coupling the correction signal to the first radio; and
a second directional coupler for extracting the sample signal and for coupling the correction signal to the second radio.

3. The apparatus of claim 2, further comprising:
a third directional coupler for extracting the error signal when the second radio is transmitting; and
a fourth directional coupler for extracting the error signal when the first radio is transmitting.

4. An apparatus comprising:
first and second radios;
an antenna;
a four-port combiner connected between each of the first and second radios and the antenna, wherein the four-port combiner produces a sample signal;
a complex vector modulator for producing a correction signal in response to the sample signal and an error signal;
a first switch for routing the correction signal to one of the first and second radios; and
a second switch for routing the error signal to the complex vector modulator.

5. The apparatus of claim 4, further comprising:
a first directional coupler for coupling the correction signal to the first radio; and
a second directional coupler for coupling the correction signal to the second radio.

6. The apparatus of claim 5, further comprising:
a third directional coupler for extracting the error signal when the second radio is transmitting; and
a fourth directional coupler for extracting the error signal when the first radio is transmitting.

7. An apparatus comprising:
first and second radios;
an antenna;
a four-port combiner connected between each of the first and second radios and the antenna, wherein the four-port combiner produces a sample signal;
a complex vector modulator for producing a correction signal in response to the sample signal and an error signal;
a circulator for routing the correction signal to the four-port combiner; and
a switch for routing the error signal to the complex vector modulator.

8. The apparatus of claim 7, further comprising:
a first directional coupler for extracting the error signal when the second radio is transmitting; and
a second directional coupler for extracting the error signal when the first radio is transmitting.

9. The apparatus of claim 7, wherein the complex vector modulator and the circulator are connected to form an active radio frequency termination.
